(19) United States
(12) Patent Application Publication
(10) Pub. No.: US 2019/0217416 A1
(43) Pub. Date: Jul. 18, 2019

(54) METHODS AND SYSTEM INVOLVING ADDITIVE MANUFACTURING AND ADDITIVELY-MANUFACTURED ARTICLE

(71) Applicant: Mathieu BROCHU, Saint-Hubert (CA)

(72) Inventor: Mathieu BROCHU, Saint-Hubert (CA)

(21) Appl. No.: 16/324,622

(22) PCT Filed: Aug. 10, 2017
(86) PCT No.: PCT/GB2017/052359

§ 371 Date: Feb. 11, 2019

Related U.S. Application Data
(60) Provisional application No. 62/372,941, filed on Aug. 10, 2016.

(30) Foreign Application Priority Data
Feb. 2, 2017 (GB) 1701702.1

(51) Int. Cl. B23K 26/34; B33Y 10/00; B33Y 30/00; B33Y 50/02; B23K 26/354; G06F 17/50

(52) U.S. Cl. CPC B23K 26/34; B33Y 10/00; G06F 17/5086; B33Y 50/02; B23K 26/354; B33Y 30/00

(57) ABSTRACT

The additively-manufactured article generally has a plurality of slices fused atop one another, at least one of the plurality of slices having a first portion including a first microstructure and a second portion including a second microstructure.

### FIELD

The improvements generally relate to additive manufacturing systems and more specifically to powder bed additive manufacturing systems.

### BACKGROUND

Additive manufacturing techniques are widely used in today's world to manufacture solid articles for applications such as rapid prototyping and/or rapid manufacturing. In some applications, the articles may be used as is, whereas in some other applications, the articles can be parts or components for use in a greater assembly. In other applications still, only a portion of the manufactured article is used, with unused portions being used to support the used portion during manufacturing and being discarded thereafter.

Powder bed additive manufacturing techniques are a subgroup of additive manufacturing techniques which involve the deposition of material in powder form. Examples of such techniques are selective laser melting (SLM) and electron beam melting (EBM), which both involve heating the powder above a melting point to cause solidification of the molten powder.

Although existing powder bed additive manufacturing systems are satisfactory to a certain degree, there remains room for improvement.

### SUMMARY

This disclosure describes a powder bed additive manufacturing technique by which the energy pulse parameter and/or the raster parameters (e.g., speed and/or path) can be changed during the creation of a layer of the article from the powder in a sequence to create two or more portions of the layer having different microstructures. The different microstructures can have respective, different mechanical properties. Accordingly, the method can be harnessed to manufacture an article of a single material having mechanical properties which vary depending on the location of the corresponding microstructures within the article.

In accordance with an aspect, there is provided a computer-implemented method of generating processing instructions for use in manufacturing a solid article in a given material from powder using a powder bed additive manufacturing system, the method comprising: obtaining a model of the article; receiving an indication of a first microstructure of the material for a first region of the model, the first microstructure being associated to a first cooling rate threshold based on solidification data; determining a first sequence of energy pulses associated to the first region, wherein a parameter of each energy pulse is adapted to melt powder material and achieve a cooling rate for the material during solidification above the first cooling rate threshold and generating the processing instructions based on the first sequence of energy pulses.

Determining the first sequence of energy pulses may comprise, for each energy pulse, taking into consideration the temperature of adjacent material to the powder material melted by the energy pulse. Determining the first sequence of pulses associated to the first region may comprises, for each energy pulse, taking into consideration the temperature of the adjacent material as affected by cooling and by heating via previous or subsequent energy pulses. Determining the first sequence of pulses associated to the first region may comprise, for each energy pulse, taking into consideration the temperature of the adjacent material as affected by cooling and by heating via previous or subsequent energy pulses used to melt powder material. Determining the first sequence of pulses associated to the first region may comprise spacing each energy pulse of the sequence in time and/or distance such that a temperature of the adjacent material at a time of the energy pulse is insignificantly influenced by previous and/or subsequent energy pulses. Heat transfer from a voxel of material subjected to the energy pulse to the adjacent material, and therefore, the cooling rate, may be determined based upon the adjacent material being within a given temperature difference tolerance, such as within a predetermined tolerance of an ambient temperature of the powder material, e.g. 400K or below. The temperature tolerance for the adjacent material is material dependent. In this way, heat transfer from the molten material can be determined independently from heating of the powder material carried out by previous or subsequent energy pulses. The minimum time before adjacent material is subjected to an energy pulse and/or a minimum distance for a subsequent energy pulse may be determined based on a time and/or distance over which heat added through the energy pulse has such an insignificant influence on local heating of the powder material. The first sequence of pulses associated to the first region may be determined from a time-distance relationship, which defines how the minimum distance from each energy pulse changes with time. The minimum time, minimum distance and/or time-distance relationship for each energy pulse may be determined taking into account factors that affect heat transfer from the molten material and heat input into the molten material, such as one or more of type of powder material, thickness of powder layer, volume of material built, energy of the energy pulse, such as energy density of the energy pulse, a pulse shape, a pulse width, a pulse amplitude, a pulse frequency, a power ramp-up parameter, a power ramp down parameter and duration of the energy pulse.

In accordance with another aspect, there is provided a method of manufacturing a solid article in a given material from powder using a powder bed additive manufacturing system, the method comprising: receiving the aforementioned processing instructions; and successively manufacturing each slice of the solid article atop one another based on the received processing instructions.

In accordance with another aspect, there is provided an additively-manufactured article comprising a plurality of slices fused atop one another, at least one of the plurality of slices having a first portion including a first microstructure and a second portion including a second microstructure.

In accordance with another aspect, there is provided an additive manufacturing system comprising: one of a selective laser melting system and an electron beam melting system; a computer coupled to the one of the selective laser melting system and the electron beam melting system and configured for obtaining a model of the article; receiving an indication of a first microstructure of the material for a first region of the model, the first microstructure being associated to a first cooling rate threshold based on solidification data; determining a first sequence of energy pulses associated to the first region, wherein a parameter of each energy pulse is adapted to melt powder material and achieve a cooling rate for the material during solidification above the first cooling rate threshold and generating the processing instructions based on the first sequence of energy pulses.

The computer may be configured for determining the first sequence of pulses associated to the first region by, for each energy pulse, taking into consideration the temperature of adjacent material to the powder material melted by the energy pulse. The computer may be configured for determining the first sequence of pulses associated to the first region by taking into consideration the temperature of the adjacent material as affected by cooling and by heating via previous or subsequent energy pulses.

In accordance with another aspect, there is provided a computer-implemented method of generating processing instructions for use in manufacturing a solid article in a given material from powder using a powder bed additive manufacturing system, the method comprising: obtaining a model of the article; receiving an indication of a first microstructure of the material for a first region of the model, the first microstructure being associated to a first yield stress threshold based on solidification data; determining a first sequence of energy pulses associated to the first region, wherein a parameter of each energy pulse is adapted to melt powder and achieve a microstructure having an associated yield stress one or above or below the first yield stress threshold and generating the processing instructions based on the first sequence of energy pulses.

Determining the first sequence of energy pulses may comprise, for each energy pulse, taking into consideration the microstructure and associated yield stress of adjacent material to the material melted by the energy pulse. Determining the first sequence of energy pulses may comprise, for each energy pulse, taking into consideration the microstructure and associated yield stress of adjacent material to the material melted by the energy pulse as can be affected by melting and by solidifying via previous or subsequent energy pulses.

According to another aspect of the invention there is provided a computer-implemented method of generating processing instructions for use in manufacturing a solid article in a given material from powder using a powder bed additive manufacturing system, the method comprising:

obtaining a model of the article;
determining a sequence of energy pulses for forming the article using the additive manufacturing apparatus, wherein a parameter of each energy pulse of the sequence is determined such that the powder is melted by heating the powder in a conduction mode, and
generating the processing instructions based on the first sequence of energy pulses.

The parameter of each energy pulse of the sequence and/or the sequence of energy pulses may be determined such that no significant heating of the powder occurs in a keyhole mode.

The parameter of each energy pulse of the sequence and/or the sequence of energy pulses may be determined such that a solidification front velocity and/or cooling rate is sufficient to disrupt a liquid film of molten material formed by heating the powder with the energy pulses. The parameter of each energy pulse of the sequence and/or the sequence of energy pulses may be determined such that a solidification front velocity and/or cooling rate is above a predetermined threshold. The predetermined threshold may be such that a solidification front velocity of the molten material is above 10⁻¹ m/s.

It will be understood that the expression “computer”, as used herein, is not to be interpreted in a limiting manner. It is rather used in a broad sense to generally refer to the combination of some form of one or more processing units and some form of memory system accessible by the processing unit(s). A computer can be a network node, a personal computer, a smart phone, an appliance computer, etc.

It will be understood that the various functions of the computer, or more specifically of the processing unit or of the memory controller, can be performed by hardware, by software, or by a combination of both. For example, hardware can include logic gates included as part of a silicon chip of the processor. Software can be in the form of data such as computer-readable instructions stored in the memory system. With respect to a computer, a processing unit, a memory controller, or a processor chip, the expression “configured to” relates to the presence of hardware, software, or a combination of hardware and software which is operable to perform the associated functions.

It will be understood that the expression “voxel”, as used herein, is not to be interpreted in a limiting manner. It is rather used in a broad sense to generally refer to a volume element whose position in three-dimensional coordinates can be determined, for example, because of three dimensional coordinate data associated with the volume element or an order in which the volume element occurs in a data set. The volume elements may partially overlap and, as such, may comprise non-tessellating volumes. An adjacent voxel may be a voxel that shares a border or partially overlaps with a voxel of interest. The voxel may approximate a melt pool generated by an energy pulse.

Many further features and combinations thereof concerning the present improvements will appear to those skilled in the art following a reading of the instant disclosure.

### DESCRIPTION OF THE FIGURES

In the figures,

FIG. 1 is a schematic view of an example of a selective laser melting system, in accordance with an embodiment;

FIG. 1A is a schematic top plan view of an example of a plurality of voxels, in accordance with an embodiment;

FIG. 2 is a schematic top plan view of a conventional raster path showing a plurality of islands;

FIG. 3 is a flow chart of an example method of manufacturing a solid article in a given material from powder using the selective laser melting system of FIG. 1, in accordance with an embodiment;

FIG. 4 is a flow chart of an example of a method of generating processing instructions for use in manufacturing a solid article in a given material from powder using the selective laser melting system of FIG. 1, in accordance with an embodiment;

FIG. 5 is a graph of a first example of solidification data, in accordance with an embodiment;

FIG. 6 is a graph showing a pulse shape usable to generate a laser pulse having the corresponding shape, in accordance with an embodiment;

FIG. 7 is a graph showing cooling curves associated with the cooling of a molten voxel when heated using laser pulses generated using different parameters, in accordance with an embodiment;

FIG. 8 is a block diagram of an example computer for implementing the method of FIG. 4;

FIG. 9 is a graph of a second example of solidification data, in accordance with an embodiment;

FIG. 10 is a graph of a third example of solidification data, in accordance with an embodiment;

FIG. 11 is a graph of a fourth example of solidification data, showing Hunt's criterion, in accordance with an embodiment;

FIG. 12A is an oblique view of a slice having a first portion and a second portion, each portion having a different microstructure, in accordance with an embodiment;

FIG. 12B is a schematic top plan view of first and second regions of voxels of a plurality of voxels, each of the first and second regions being associated with a respective one of the first and second portions of FIG. 12A, in accordance with an embodiment;

FIG. 12C is a schematic top plan view of a first sequence of laser pulses used to melt a first region of voxels of FIG. 12B to manufacture the first portion of FIG. 12A;

FIG. 12D is a schematic top plan view of a second sequence of laser pulses used to melt a second region of voxels of FIG. 12B to manufacture the second portion of FIG. 12A;

FIG. 13 is a sectional side view of the SLM system of FIG. 1, showing an article including a part and a support structure; and

FIG. 14 is a flow chart of an example algorithm for generating processing instructions, in accordance with an embodiment.

### DETAILED DESCRIPTION

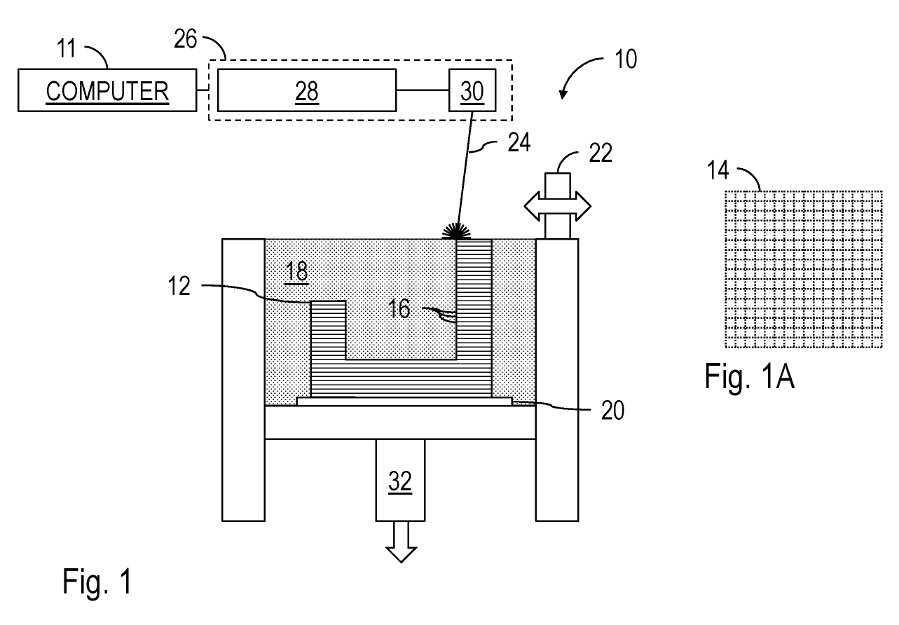

A powder bed additive manufacturing system, an example of which is shown at 10 in FIG. 1, manufactures a given article 12 according to a 3D model in a layer-by-layer arrangement.

In some embodiments, the powder bed additive manufacturing system is a selective laser melting (SLM) system whereas in some other embodiments, the powder bed additive manufacturing system is an electron beam melting (EBM) system. Both these systems are configured to provide energy pulses to powder in order to manufacture the solid article 12. In the case of the SLM system, these energy pulses are laser pulses. In the case of the EBM system, these energy pulses are electron beam pulses.

For ease of reading, the powder bed additive manufacturing system 10 described in the following paragraph is a SLM system (hereinafter “the SLM system 10”). However, it will be understood that the methods and systems described herein can involve the EBM system. Other embodiments may also apply.

In additive manufacturing techniques, the 3D model is processed with a computer 11 so as to divide it into a plurality of horizontal pluralities of voxels. For ease of understanding, a top view of a first one of the pluralities of voxels is shown at 14 in FIG. 1A. Each slice of the article 12 is thus manufactured based on a corresponding plurality of voxels, and fused with an underlying slice to manufacture a dense, strong article. The article 12 so manufactured thus includes a plurality of superposed and fused slices 16 of solidified powder.

Broadly described, the SLM system 10 includes a base plate 20 onto which a first layer of powder 18 is deposited using a powder deposition mechanism 22. Then, a laser beam 24 is scanned onto the first layer of powder 18 using a laser scanning subsystem 26 (e.g., including a laser source 28 and one or more scanning mirrors 30) so as to redirect the laser beam 24 onto the first layer of powder 18, and more specifically, onto powder in each voxel of the first plurality 14. The powder in each voxel (hereinafter “each voxel”) that receives the laser beam 24 heats, melts, and then cools so as to solidify with adjacent voxels of the first plurality 14 into a first slice of the article 12. Then, a piston 32 drops the base plate 20 of a given vertical distance, a second layer of powder 18 is deposited over the first slice, a second slice of the article 12 is manufactured atop the first slice by selectively laser-scanning each voxel of a second one of the pluralities of voxels, and so forth until the article 12 is completed.

It is noted that the sequence in which each voxel of a plurality is scanned by the laser scanning subsystem 26 is referred to as a “raster path”. The raster path of a plurality of voxels is typically determined by the computer 11, and it can vary from one slice to another.

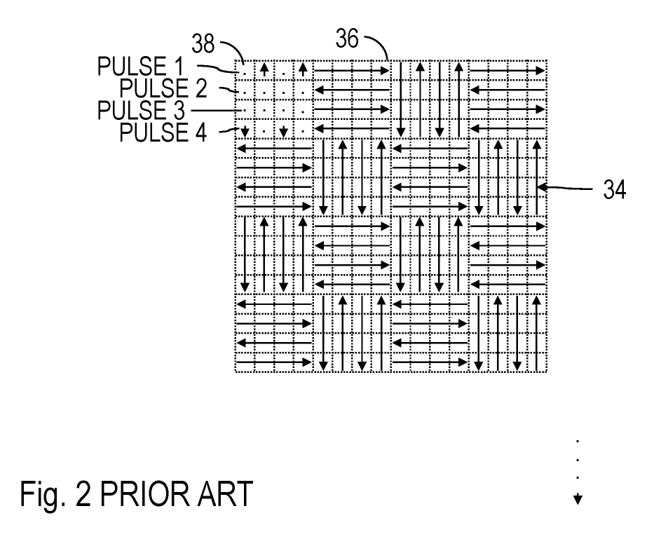

For instance, an example of a conventional raster path 34 associated with an example plurality 36 of voxels is shown in FIG. 2. More specifically, the conventional raster path 34 is illustrated via the plurality of arrows arranged in islands. As can be seen, the conventional raster path 34 includes a zig-zag type of laser-scanning pattern so as to fully heat and melt each voxel of the plurality 36 as quickly as possible. Indeed, conventional raster paths are determined on an efficiency basis so as to reduce the laser-scanning time to scan each of the voxels of a given plurality of voxels at a given speed. In most cases, this given speed is an optimal speed, i.e. the maximum speed that can yield article of satisfactory quality.

The laser source 28 can be a pulse wave (PW) laser source, which generates a PW laser beam, and the conventional raster path 34 typically includes coordinates of a series of voxels where laser pulses are to be successively directed, as best shown only in the uppermost and leftmost island 38 for clarity. However, other type of laser systems could be used, such as a modulated continuous wave (CW) laser, for generating a series of laser pulses.

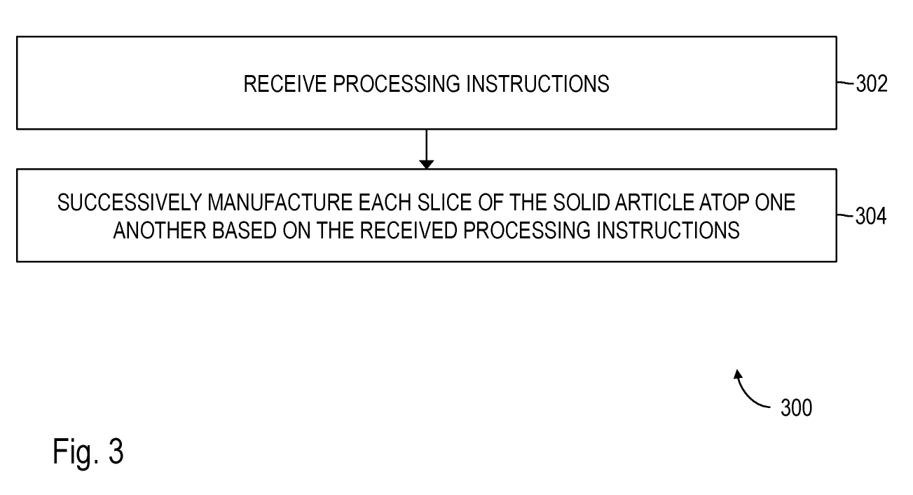

Accordingly, FIG. 3 is an example of a flow chart of a method 300 of manufacturing a solid article in a given material from powder using the SLM system 10. As depicted, at step 302, the computer receives processing instructions and at step 304, the SLM system 10 successively manufactures each slice of the solid article atop one another based on the received processing instructions. As it will be understood, in conventional techniques, the processing instructions are based on the 3D model of the pluralities of voxels as well as on the conventional raster path 34.

Physics teaches that the cooling rate of molten powder in a given voxel (hereinafter “the molten voxel”) defines a final microstructure of solidified powder in the given voxel (hereinafter “the solidified voxel”), and that the final microstructure of the solidified voxel is indicative of its mechanical properties. The cooling rate CR is generally given by the product of a solidification front velocity R and a thermal gradient G, i.e. CR=R·G. For one cooling rate CR, there exists a multitude of combinations of R and G.

Understandably, the cooling rate of each of the molten voxels of a plurality can impact the mechanical properties of the corresponding slice as it solidifies, and therefore the cooling rate of each of the molten voxels of each of the pluralities of an article can impact the mechanical properties of the final article.

The cooling rate of each voxel of an article is thus of importance if mechanical properties of the article are to be controlled by a SLM system.

However, it was found that with conventional SLM systems, no consideration is given to the cooling of each molten voxel. Indeed, since conventional raster paths (e.g., the conventional raster path 34) are determined on an efficiency basis only, each molten voxel cools in a manner dependent on the temperature of its surroundings such that powder in a given voxel (hereinafter “the given voxel”) typically cools at a varying or uncontrolled cooling rate due to the temperature of adjacent molten voxels, which prevents controlling the final microstructure of the given voxel.

It was found that i) by melting each voxel of the plurality 14 using a laser pulse generated with a parameter specifically chosen so as to melt a given voxel to a given temperature such that it cools at an expected cooling rate associated with a final microstructure thereafter and ii) by using a sequence of laser pulses carefully determined so that each molten voxel of the plurality 14 cools at an expected cooling rate associated with a final microstructure thereafter while any adjacent voxels have a temperature within a given temperature difference tolerance (e.g., 400 K, or below), the SLM system 10 can manufacture a slice solidified into the final microstructure.

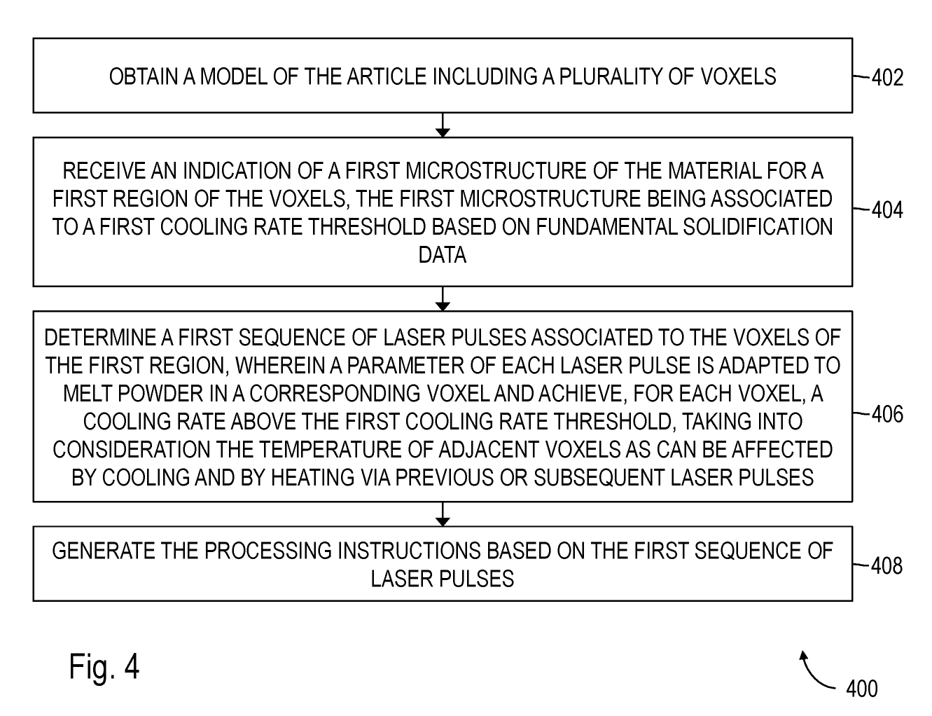

FIG. 4 is an example of a flow chart of a computer-implemented method 400 of generating processing instructions, such as those received at step 302 of the method 300 of FIG. 3, for use in manufacturing a solid article in a given material from powder using SLM system 10. Reference will thus be made to the SLM system 10 of FIG. 1 throughout the description of the method 400 for ease of reading.

The method 400 is used to generate processing instructions for manufacturing a slice of the article 12. However, the method 400 can also be used successively, or generalized, to generate processing instructions for manufacturing all slices of the article 12. The method 400 is described with reference to the manufacture of a single slice of the article 12 for simplicity purposes only.

At step 402, the computer 11 obtains a model of the article 12 including a plurality of voxels, such as the plurality 24 of voxels shown in FIG. 1A. The voxels of a given plurality are generally in-plane. The model can include one or more pluralities of “in-plane” voxels.

At step 404, the computer 11 receives an indication of a final microstructure of the material for a region of the voxels. The final microstructure is associated to at least one cooling rate threshold based on solidification data and represents the microstructure in which powder in voxels of the region is expected to be solidified into.

As it will be understood, the plurality 14 of voxels need not necessarily be a square matrix of voxels such as the one shown in FIG. 1A. Indeed, the plurality 14 of voxels can have any configuration of voxels in-plane relatively to one another. The configuration of the plurality of voxels depends on the shape of the article to be manufactured.

In some embodiments, the region referenced to in step 404 extends over the plurality 24 of voxels. In some other embodiments, as will be described herebelow, the region extends over only a fraction of the plurality 24 of voxels.

The indication can be received from a user interface of the computer 11. Examples of user interface can include a keyboard, a mouse, a touch screen, a button or any other suitable user interface. In alternate embodiments, the indication can be received from a network (e.g. the Internet) to which the computer 11 is in communication with (e.g., a wired connection, a wireless connection).

In some embodiments, the microstructure in which the powder is expected to be solidified into refers to a crystalline structure of the solidified voxel. For instance, the crystalline structure of the microstructure of the solidified voxel may be dendritic or cellular depending on the alloy composition.

In alternate embodiments, the microstructure in which the powder is expected to be solidified into refers to a primary phase of the solidified voxel.

However, in some other embodiments, the microstructure in which the powder is expected to be solidified into refers to a size of a given crystalline structure of the solidified voxel (i.e. a “crystalline structure size”). The crystalline structure size can be a grain size, a dendrite size or a cell size.

Selecting the microstructure in which the molten voxels solidify into can help determining the mechanical properties of the solidified voxels. Yield strength, hardness and toughness are example of mechanical properties that can be influenced by the microstructure. Other mechanical property may be influenced by the microstructure.

For instance, the yield strength σy of a crystalline structure varies as function of the reciprocal of the grain size d as per the Hall Petch relationship, where σy∝1/d^{1/2}. Indeed, in this example, the finer the grain size of a microstructure, the higher the yield strength of this microstructure is. The crystalline structure and the phase of the solidified voxel may also influence the yield strength of the solidified voxel.

Examples of such solidification data can include continuous cooling transformation (CCT) data, time-dependent nucleation model, solidification growth data (e.g., Kurz-Giovanola-Trivedi (KGT) data), Hunt's criterion data, processing maps, or any combination thereof.

The solidification data are intrinsically linked with the material of the powder, and can be retrieved from scientific literature in some cases, or be calculated based on a computer simulation (e.g., time-dependant nucleation model) in some other cases. The solidification data can be provided in the form of a curve, a mathematical relation or a lookup table, depending on the embodiments. However, other embodiments may apply.

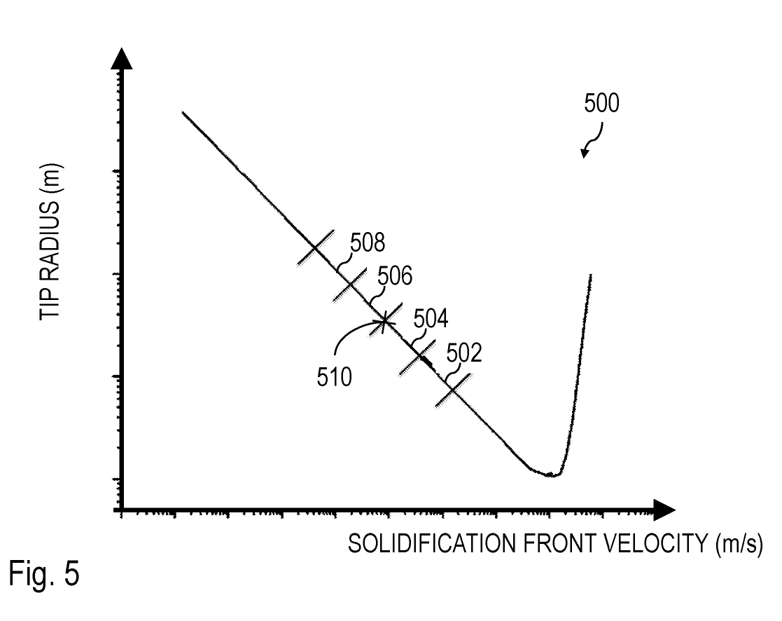

FIG. 5 shows a first example of solidification data, in the form of a KGT curve 500. As depicted in this example, for a given material, a molten voxel of this material may solidify into a dendritic microstructure, but characterized in one of a plurality of crystalline structure size ranges.

More specifically, depending on the cooling rate of the molten voxel, the solidified voxel may have a crystalline structure size among one of a plurality of crystalline structure size ranges R1, R2, R3 and R4 associated with each of the plurality of curve segments 502, 504, 506, 508, respectively. Curve segment 502 is generally associated with a crystalline structure size range that is finer than curve segment 508. The length and the number of curve segments shown in FIG. 5 can vary; curve segments 502, 504, 506, 508 are only exemplary.

In this specific example, the final microstructure can be linked with the solidification front velocity R, and thus the cooling rate threshold can be obtained using the relation CR=R·G by adjusting the thermal gradient G generated by the laser pulse shape for the required solidification front velocity R.

For instance, if the final microstructure is expected to have a crystalline structure size comprised greater than crystalline structure size range R2, the target point on the KGT curve 500 is the upper limit of the curve segment 504, as shown at 510, along the KGT curve 500. In this case, the cooling rate threshold is the cooling rate of a cooling curve (temperature versus time) of a molten voxel that intersects the KGT curve 500 at the target point 510. Accordingly, the molten voxels solidify in such a final microstructure when the cooling rate of each molten voxel is above the cooling rate threshold.

At step 406, the computer 11 determines a sequence of laser pulses associated to the voxels of the region, wherein a parameter of each laser pulse is adapted to melt powder in a corresponding voxel and achieves, for each voxel, a cooling rate above the cooling rate threshold, taking into consideration the temperature of adjacent voxels as can be affected by cooling and by heating via previous or subsequent laser pulses.

In some embodiments, the parameter is generally used to instruct the laser source 28 to generate a laser pulse having a given energy distribution. Examples of parameters includes a pulse shape, a pulse width, a pulse amplitude, a pulse frequency, a pulse energy, a power ramp-up parameter, a power ramp down parameter and the like.

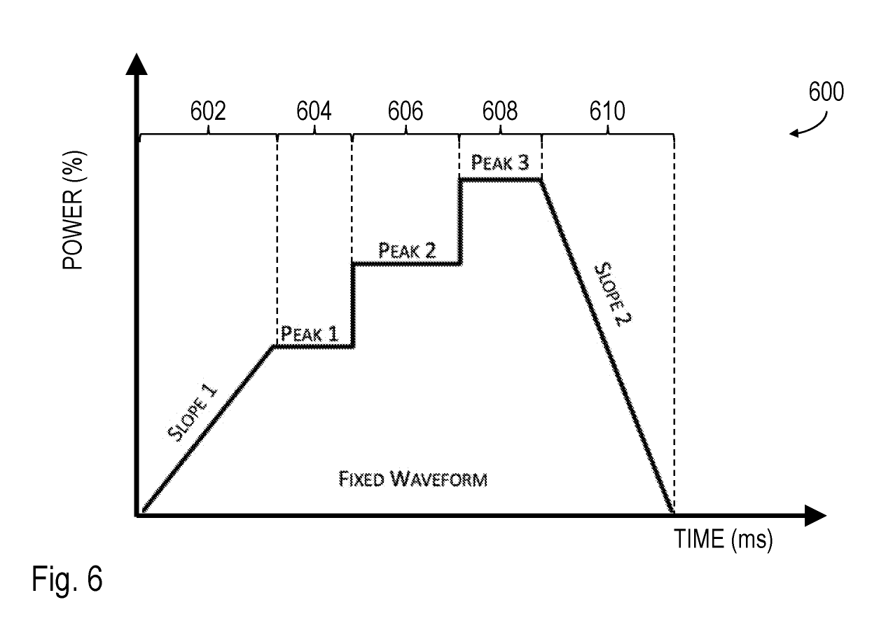

A pulse shape may include a plurality of sub shapes in which each one of the sub shapes can have different duration, energy, ramp up or down and the like. For instance, FIG. 6 shows an example of a laser pulse 600 having sub shapes 602, 604, 606, 608 and 610.

In this case, the sub shape 602 has an increasing slope during a first duration, the sub shape 604 has a first plateau at a first amplitude during a second duration, the sub shape 606 has a second plateau at a second amplitude greater than the first amplitude during a third duration, the sub shape 608 has a third plateau at a third amplitude greater than the second amplitude during a fourth duration and the sub shape 610 has a decreasing slope during a fifth duration. In one example, the total duration of the laser pulse 600 can vary between 0.2 ms and 10 ms. However, as it will be understood, other suitable examples of pulse shape, pulse parameter, or time duration, may apply.

In some embodiments, the cooling rate at which a molten voxel may cool is determined through computer simulation. Such a computer simulation can depend on many variables. For instance, such a cooling rate can vary depending on a voxel size, properties of the powder, the laser pulse absorption of the powder, the parameter used to generate the laser pulse and a surrounding of the given voxel, i.e. the presence or absence of any adjacent voxels which can provide more or less thermal inertia, the temperature associated with each of such adjacent voxels, the influence of the base plate 20 (heat absorption near the base plate 20 is higher than when the molten voxel is higher relatively to the base plate 20), in your category properties of the powder material.

In these embodiments, most of the aforementioned variables (e.g., voxel size, the properties of the powder, the presence or absence of any adjacent voxels) are known.

In some cases, such as the one exemplified in this disclosure, the temperature associated with each of such adjacent voxels is fixed as being within a temperature difference tolerance indicative of the maximal temperature difference allowed between the given molten voxel and any adjacent voxel. Accordingly, by fixing the temperature difference tolerance, the cooling of a molten voxel is independent from its surrounding, and thus solving for the parameter which can yield the desired cooling rate remains.

It will be understood, as per thermodynamics laws, if a first voxel is molten with a first laser pulse of greater energy (generated using a first parameter) and a second voxel is molten with a second laser pulse of lower energy (generated using a second parameter), and that the first and second voxels are independent from one another in a similar thermal environment, the first voxel will typically heat at a temperature higher than that of the second voxel. Therefore, the first voxel will have a greater temperature difference with its environment and thus cool faster than the second voxel.

Using this rationale, for two independent molten voxels, a first parameter indicative of a laser pulse of greater energy will generally cause a molten voxel to cool at a greater cooling rate than a second parameter indicative of a laser pulse of lower energy.

A sequence of energy pulses is determined to ensure that heat transfer from each molten voxel can be determined independently from heat input into the powder material though other energy pulses of the sequence. The sequence may comprise providing sufficient spacing between the energy pulses in time and/or distance to ensure that heat transfer from each molten voxel can be modelled independently from the other molten voxels.

A temperature difference between the molten voxels and the adjacent material is such that a sufficiently fast solidification front velocity is achieved to disrupt the morphology of a liquid film formed between dendrites of solidified material, e.g. a solidification front velocity above 10⁻¹ m/s. It is believed that disruption of the morphology of the liquid film results in a discontinuous liquid film, reducing the likelihood of cracking. Strain will still exist during solidification but there will be increased dendrite coherency. This solidification of molten material with such a fast solidification front velocity can be contrasted with slowing down the solidification front velocity, for example to less than 10⁻⁴ m/s by preheating the adjacent material, resulting in liquid backfilling to heal cracks.

The parameters used for the energy pulses is such that heating of the powder material to form the molten voxel is achieved in the “conduction mode”. In conduction mode heating, a power density of the energy pulse is sufficiently high to cause the powder material to melt but penetration of the material is achieved by the heat being conducted down into the powder material from the surface. A depth of the molten voxel is controlled, in part, by the length of the energy pulse and the powder the energy pulse. It has been found that power is the main factor influencing melt pool depth, whereas a time of the exposure has more of an influence on melt pool width. This mode of conduction can be contrasted with the keyhole conduction mode, which is conventionally used, wherein a power density is great enough to vaporise the powder material. The vaporising material produces expanding gas that pushes outwards creating a keyhole or tunnel from the surface down to the depths of the molten voxel.

A potential advantage of operating in the conduction mode is that is may reduce splatter and condensate generated during formation of the article. For machines that operate in keyhole mode, this splatter and condensate is removed during solidification using a gas knife with the entrained particulate material being removed from the gas flow using a filter. Such filters require periodic replacement, which is a hazardous activity as the particles on the filter element can combust when in an oxygen atmosphere. Any particulate matter that remains within the build chamber during the build can affect the passage of the energy beam. For example, in a selective laser melting machine, particles settling on a laser window can affect the passage of the laser beam through the laser window. Accordingly, reducing splatter and condensate by operating in conduction mode can lengthen the operating life of the filter and reduce the effects of particulates on the passage of the energy beam through a build chamber.

Furthermore, as preheating of the adjacent material is avoided (undesirable), a cool down period at the end of a build may be reduced, allowing for faster turn around times between builds, and/or a powder cake avoided. Furthermore, operating at lower temperatures may reduce the likelihood of the powder material and/or solidified material reacting with any oxygen that remains in the build chamber.

As less/no material is vaporised in conduction mode, less/no oxygen may be thrown out from the powder material during melting, potentially increasing the longevity of powder batches.

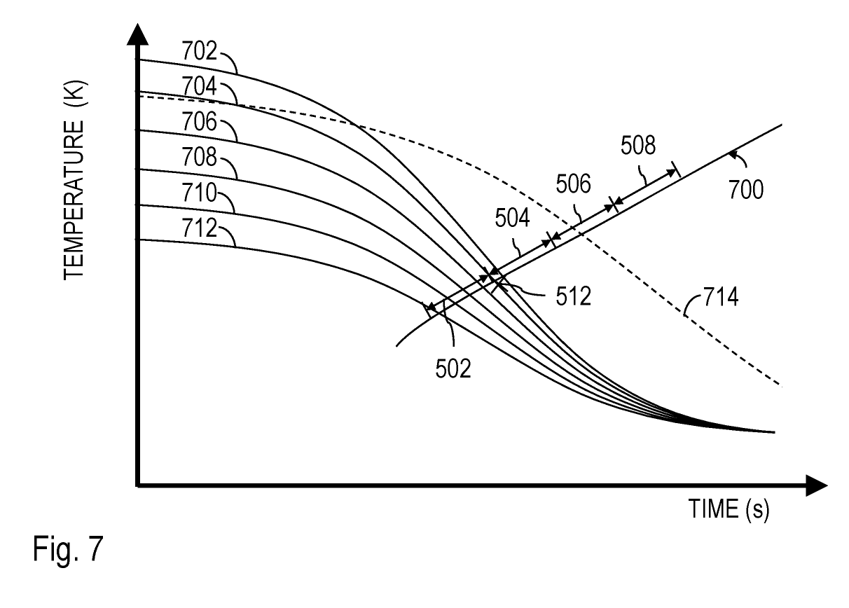

FIG. 7 shows expected exemplary cooling curves 702-714 and a solidification curve 700 obtained from the KGT curve 500 of FIG. 5. Segments 502, 504, 506, and 508 of the KGT curve 500 (associated with different crystalline structure size ranges R1-R4) are illustrated in FIG. 7, in connection with the solidification curve 700, for ease of understanding.

For instance, expected cooling curves 702, 704, 706, 708, 710 and 712 are associated with different solidification locations within a same voxel when molten using a laser pulse generated using a same parameter. In order to produce a uniform microstructure for each given voxel, the cooling rate at any point within the voxel can be chosen to fall within the curve segment 502 along the solidification curve 700 if a microstructure having the crystalline structure size range R1 is desired.

As will be understood, cooling curves 704 and 714 are associated with two different parameters for a given temperature difference tolerance. The cooling curve 704 (along with the curves 702 and 706-712) was generated based on a first parameter, and the cooling curve 714 was generated based on a second parameter different from the first parameter. As depicted, the cooling curves 704 and 714 intersect the solidification curve 700 at different locations along the solidification curve 700 and also at different cooling rates. More specifically, in this example, if a microstructure having a crystalline structure size within the crystalline structure size range R1 is desired, the computer 11 determines the first parameter associated with the cooling curve 704. Indeed, the cooling curve 704 intersects the solidification curve 700 above the target point 512 and have a cooling rate above the cooling rate threshold, which is not the case for the cooling curve 714. As it will be understood, the parameter usable to generate a laser pulse able to melt a given voxel is found as being the parameter which allows the molten voxel to cool at a cooling rate above the cooling rate threshold (see step 404).

Finding the right parameter such that a given molten voxel cools at a cooling rate above a cooling rate threshold may not be sufficient to provide a solidified voxel having the expected microstructure.

Indeed, it was found that when using conventional raster paths, the condition mentioned above regarding the maximal temperature difference was not always met such that even though the right parameter was used, the cooling rate of a given molten voxel could go below the cooling rate threshold, and thus provide a solidified voxel having a microstructure different from the expected microstructure.

In order to avoid such a situation, the computer 11 can determine a customized sequence of laser pulses. Such sequence of laser pulses is indicative of an order and of a speed at which successive voxels of the plurality 14 are to be molten using a corresponding one of the laser pulses generated using corresponding parameters.

The sequence of laser pulses is thus determined in a manner allowing each molten voxel to cool at a cooling rate above the cooling rate threshold while any adjacent voxels have a temperature within the temperature difference tolerance to let the molten voxels of the plurality 14 solidify into the expected microstructure.

At step 408, the computer 11 generates the processing instructions based on the first sequence of laser pulses.

Of course, as mentioned above, the method 400 can be successively performed, or generalized, to generate processing instructions for use in manufacturing each slice of the article 14 in the expected microstructure.

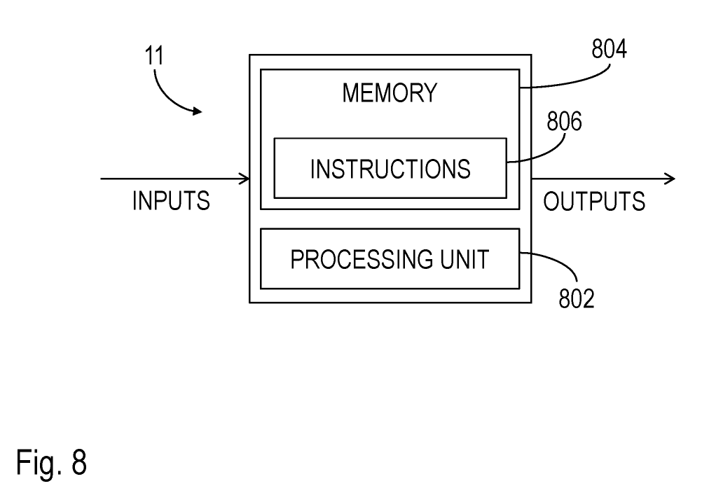

FIG. 8 shows a schematic representation of the computer 11 as a combination of software and hardware components. In this example, the computer 11 is illustrated with one or more processing units (referred to as “the processing unit 802”) and one or more computer-readable memories (referred to as “the memory 804”) having stored thereon program instructions 806 configured to cause the processing unit 802 to generate one or more outputs based on one or more inputs. The inputs may comprise one or more signals representative of the expected microstructure, the shape of the plurality of voxels, the voxel size, the properties of the powder, the laser pulse absorption of the powder, potential parameters, solidification data for a plurality of different materials, threshold(s), and the like. The outputs may comprise one or more signals representative of the determined parameter, the determined raster data, the generated processing instructions, and the like.

As it will be understood, in some embodiments, the computer 11 can be provided as part of the LSM system 10 shown in FIG. 1. However, in other embodiments, the computer 11 can be provided separately from the LSM system 10.

The processing unit 802 may comprise any suitable devices configured to cause a series of steps to be performed so as to implement the computer implemented method 300 such that the instructions 806, when executed by the computer 11 or other programmable apparatuses, may cause the functions/acts/steps specified in the methods described herein to be executed. The processing unit 802 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 804 may comprise any suitable known or other machine readable storage medium. The memory 804 may comprise non-transitory computer readable storage medium such as, for example, but not limited to, an electronic, magnetic, optical, electromagnetic, infrared, or semiconductor system, apparatus, or device, or any suitable combination of the foregoing. The memory 804 may include a suitable combination of any type of computer memory that is located either internally or externally to device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 804 may comprise any storage means (e.g., devices) suitable for retrievably storing machine-readable instructions executable by the processing unit 802.

Each computer program described herein may be implemented in a high-level procedural or object-oriented programming or scripting language, or a combination thereof, to communicate with the computer 11. Alternatively, the programs may be implemented in assembly or machine language. The language may be a compiled or an interpreted language. Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

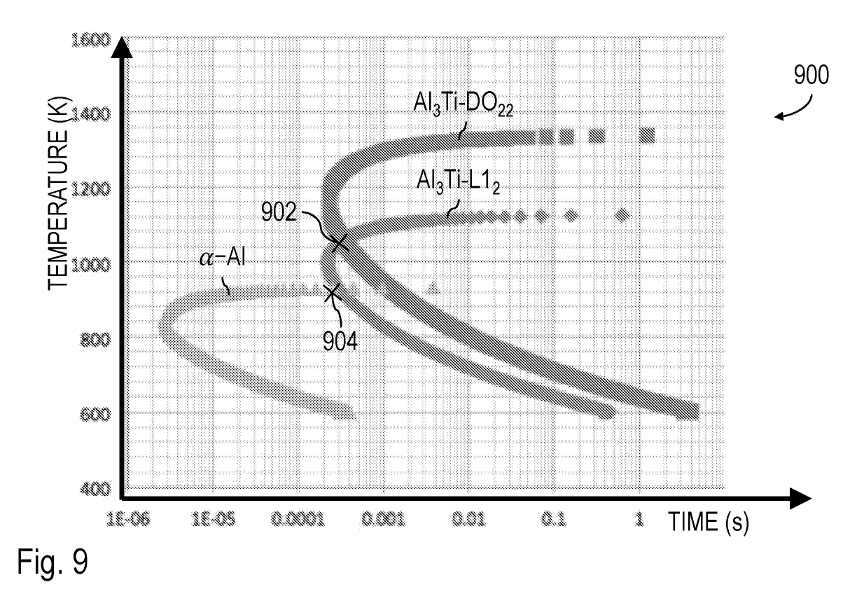

FIG. 9 shows a second example of solidification data, in the form of time dependent nucleation curves 900. As depicted, for a given material, in this case the alloy Al—Ti, a molten voxel of this alloy may solidify first into a microstructure having one of three different crystalline structure, namely a phase α-Al, a phase Al₃Ti-D0₂₂, and a phase Al₃Ti-L1₂.

In this specific example, the determination of the cooling rate threshold includes determining intersection points 902 and 904 along the CCT curves 400 associated with interfaces between the phases α-Al, Al₃Ti-D0₂₂, and Al₃Ti-L1₂.

For example, if the first phase to form in the final microstructure is expected to be the phase Al₃Ti-L1₂, the target interval on the CCT curves 900 is along the Al₃Ti-L1₂ curve and between the intersection points 902 and 904. In this case, a first cooling rate threshold is the cooling rate of a cooling curve (temperature versus time) of a molten voxel that intersects the CCT curves 900 at the intersection point 904 and a second cooling rate threshold is the cooling rate of a cooling curve (temperature versus time) of a molten voxel that intersects the CCT curves 900 at the intersection point 902. Accordingly, the molten voxels solidify in such a final microstructure when the cooling rate of each molten voxel is above the first cooling rate and below the second cooling rate. That is, when the cooling curve of a given molten voxel intersects the CCT curves between the two intersection points 902 and 904.

In this specific embodiment, the CCT curves 900 have been obtained through computer simulation by solving equations such as time-dependant nucleation models. Other embodiments may apply.

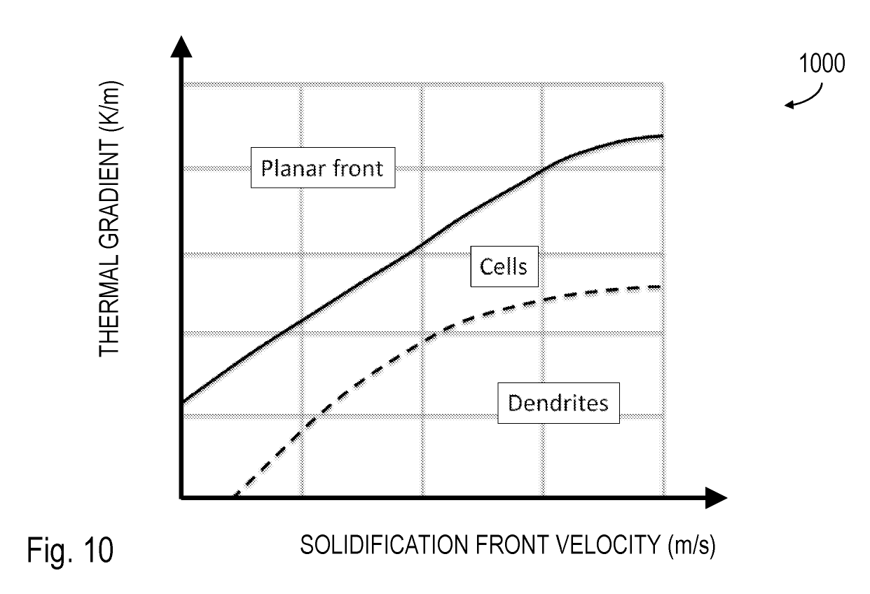

FIG. 10 shows a third example of solidification data, in the form of a first processing map 1000. As depicted, the processing map 1000, or the data contained therein, can be used by the computer 11 to determine the cooling rate threshold associated with different microstructures of a given material. The first processing map 1000 includes a KGT curve as well as other numerically calculated curves. More specifically, the first processing map 1000 can help determine a critical cooling rate associated with a microstructure having a dendritic microstructure or a cellular microstructure, of different crystalline structure sizes.

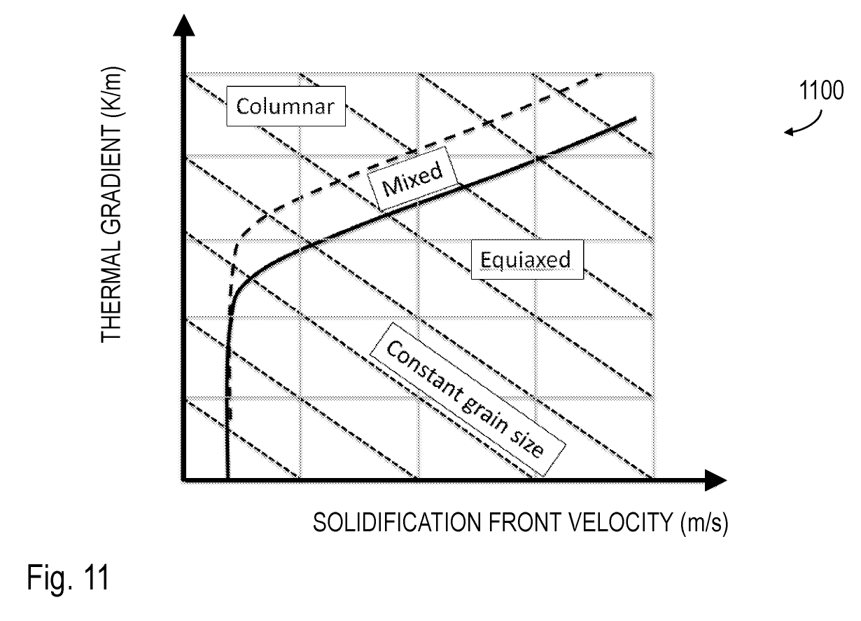

FIG. 11 shows a fourth example of solidification data, in the form of a second processing map 1100. As depicted, the processing map 1100, and the data contained therein, can be used by the computer 11 to determine the cooling rate threshold associated with different microstructures. The second processing map 1100 includes a KGT curve to distinguish dendritic from cellular microstructures and Hunt's criterion to distinguish between columnar and equiaxed microstructures. Moreover specifically, the second processing map 1100 provides constant grain size iso-lines (see dotted lines).

The solidification data may include any other suitable processing map.

It was further found that, by varying the parameter and the raster data during laser-scanning of a given plurality of voxels, a slice having a portion solidified into a first microstructure and having a second portion solidified into a second microstructure can be manufactured.

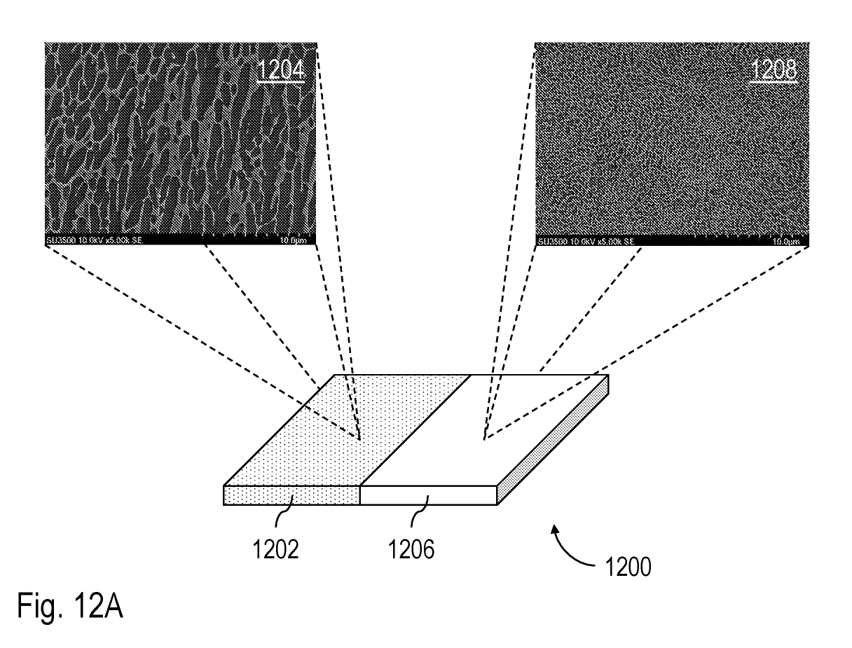

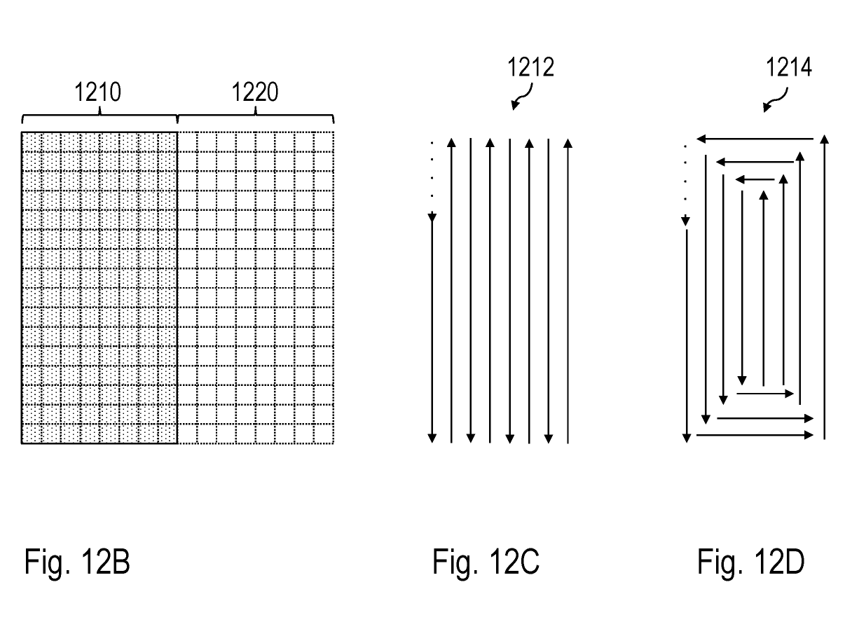

For instance, FIG. 12A shows an oblique view of an example slice 1200, in accordance with an embodiment. As depicted, the slice 1200 has a first portion 1202 solidified into a first microstructure 1204 and a second portion 1206 solidified into a second microstructure 1208. In this specific example, the first microstructure 1204 is a dendritic microstructure whereas the second microstructure 1208 is a cellular microstructure. However, other embodiments may apply. For instance, a slice can include more than two portions solidified into more than two different microstructures, depending on the application.

FIG. 12B shows a first region 1210 of voxels of a given plurality and a second region 1220 of voxels of the given plurality adjacent to one another. In this example, the first region 1210 is laser-scanned with laser pulses generated according to a first sequence of laser pulses. The first sequence of laser pulses is indicative of a first raster path, such as the one shown at 1212 in FIG. 12C, of a series of parameters used to generate each one of the successive laser pulses and of the time delays between each one of two successive laser pulses. Similarly, the second region 1220 is laser-scanned with laser pulses generated according to a second sequence of laser pulses. The second sequence of laser pulses is indicative of a second raster path, such as the one shown at 1214 in FIG. 12D, of a series of parameters used to generate each one of the successive laser pulses and of the time delays between each one of two successive laser pulses.

In some embodiments, the processing instructions generated using the method 400 include both the first and the second sequence of laser pulses. For instance, the method 300 can include a step of receiving an indication of a second microstructure of the material for a second region of the voxels, the second microstructure being associated to a second cooling rate threshold based on solidification data; and a step of determining a second sequence of laser pulses associated to the voxels of the second region, wherein a parameter of each laser pulse is adapted to achieve, for each voxel, a cooling rate above the second cooling rate threshold, taking into consideration the temperature of adjacent voxels as can be affected by cooling and by heating via previous or subsequent laser pulses. In this case, the processing instructions are based on the first and second sequences of laser pulses.

In some embodiments, the sequence in which the successive voxels of a region of a plurality of voxels are molten is predefined. The sequence may be imposed by the computer 11 or user-defined. The sequence can be set to row-per-row or column-per-column, inward or outward spiral, continuous or discontinuous. In some other embodiments, the sequence in which the successive voxels of a plurality of voxels are molten is pseudo-random or random. Other embodiments may apply.

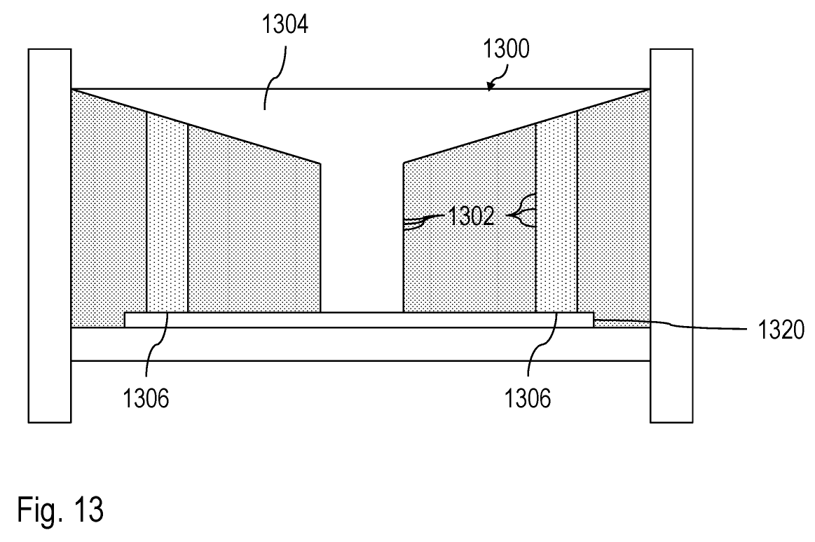

FIG. 13 shows a sectional view of an additively-manufactured article 1300, shown still in the SLM system 10 of FIG. 1. As depicted, the article 1300 is provided onto the base plate 1320. The article 1300 is manufactured using the method described above, therefore it has a plurality of slices 1302 fused atop from one another.

In this example, at least one of the plurality of slices 1302 has a part 1304 including a first microstructure and a support structure 1306 including a second microstructure. The first and second microstructures are chosen so that the part 1304 has a strength which is greater than the strength of the support structure 1306. In this way, once the article 1300 is manufactured, the support structure 1306 can be removed relatively easily from the part 1304 after manufacturing thereof. Such support structures are relevant in situations where one or more projections of the part may cause the part to break or deform beyond a tolerance inside the SLM system 10 during manufacture.

As it will be understood, an additively-manufactured article having a plurality of slices fused atop from one another can have at least one of the plurality of slices having a first portion including a first microstructure and a second portion including a second microstructure. In some embodiments, a plurality of first portions extend between superposed ones of the plurality of slices of the article and a plurality of second portions extend between superposed ones of the plurality of slices of the article. In some other embodiments, the plurality of first portions have a strength greater than a strength of the plurality of second portions.

In another embodiment, a residual stress modeling code is used in the determination of the raster data. In this way, for any given cooling rate, a residual stress field can be calculated using the residual stress modeling equation. In this embodiment, instead of using the criteria of the temperature difference tolerance to decide which one of the voxel is going to be molten next, a value of residual stress is used. For instance, 100 MPa.

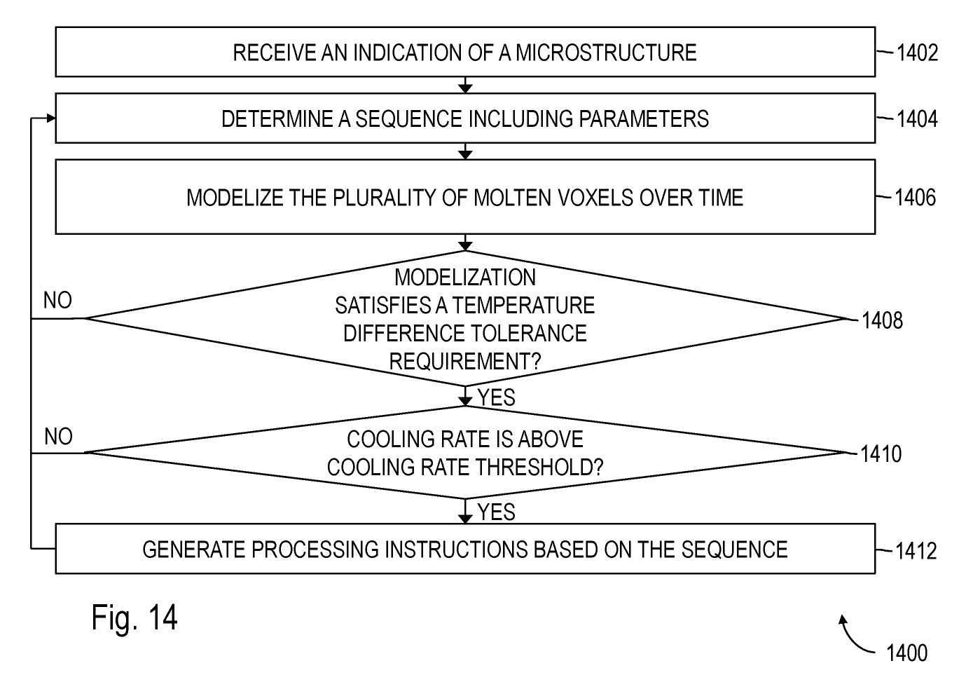

FIG. 14 shows an example of a flow chart for determining the parameter that can be used in the processing instructions of an article.

At step 1402, the computer 11 receives an indication of a microstructure. The microstructure being associated to a cooling rate threshold based on solidification data.

At step 1404 the computer 11 determines a sequence of laser pulses including a parameter associated with each of the laser pulses to be used for melting powder in each voxel of a plurality of voxels, wherein a parameter of each energy pulse is adapted to melt powder in a corresponding voxel. An initial sequence and an initial parameter may be used in step 1404 to begin the modelization.

In some embodiments, the initial sequence is a zig-zag sequence. In some other embodiments, the initial parameter is a parameter usable to generate a laser pulse having a relatively small pulse width and a relatively high energy so as to allow the faster raster speed possible.

At step 1406, the computer 11 modelizes the plurality of voxels being heated and molten by the sequence of energy pulses directed to successive voxels of the plurality. Such modelization takes into consideration the temperature of adjacent voxels as can be affected by cooling and by heating via previous or subsequent energy pulses. The modelization may be based on finite element analysis where thermal and mechanical properties of each molten voxel are factored in.

At step 1408, the computer 11 determines whether or not the modelization performed at step 1406 satisfies a temperature difference tolerance requirement in accordance within a given criteria. If the modelization does not satisfy the temperature difference tolerance requirement, the computer 11 goes back to step 1404 and determine another sequence of laser pulses including parameters and so forth. If the modelization does satisfy the temperature difference tolerance requirement, the computer 11 moves on to step 1410.

At step 1410, the computer 11 determines whether or not each molten voxel cools at a cooling rate above the cooling rate threshold based on the modelization performed at step 1406. If the cooling rate of a given number of molten voxels (e.g., 1) is found to be below the cooling rate threshold, the computer 11 goes back to step 1404 and determines another sequence of laser pulses including parameters and so forth. Otherwise, the computer 11 moves on to step 1412 where processing instructions are generated based on the last sequence.

As iterations are made in the flow chart 1400, the sequence can go from a zig-zag pattern, to a pseudo random pattern, to a random pattern, the raster speed can go from a first raster speed, to a second raster speed smaller than the first raster speed and so forth, the parameter can go from a first parameter indicative of a first energy, to a second parameter indicative of a second energy smaller than the first energy and so forth. An objective in these iterations is to provide the fastest sequence as possible which can provide the desired microstructure.

Global optimization methods such as genetic algorithms, pattern searches, simulated annealing can be performed depending on the application.

As depicted, initial inputs such as initial parameter and initial raster path are determined. In some embodiments, the initial parameter is chosen so as to generate a laser pulse having the shortest pulse width possible and the highest energy possible whereas the initial raster path is chosen to be in a zig-zag form. Once the initial parameter and the initial raster path is determined, the modelization is performed. If the conditions 1408 and 1410 are not met, the computer 11 can modify the initial parameter and/or the initial raster path and perform another iteration of the modelization with the modified parameter and raster path, and so forth, until all the conditions 1408 AND 1410 are met. Once the conditions 1408 and 1410 are met, the computer 11 generates the processing instructions based on the latest parameter and raster path.

A computer-implemented method of generating processing instructions for use in manufacturing a solid article in a given material from powder using the SLM system 10 is also described. This method has the step of obtaining a model of the article including a plurality of voxels; receiving an indication of a first microstructure of the material for a first region of the voxels, the first microstructure being associated to a first yield stress threshold based on solidification data; determining a first sequence of energy pulses associated to the voxels of the first region, wherein a parameter of each energy pulse is adapted to melt powder in a corresponding voxel and achieve, for each voxel, a microstructure having an associated yield stress either above or below the first yield stress threshold, taking into consideration the microstructure and associated yield stress of adjacent voxels as can be affected by melting and by solidifying via previous or subsequent energy pulses; and generating the processing instructions based on the first sequence of energy pulses.

As can be understood, the examples described above and illustrated are intended to be exemplary only. For instance, the aforementioned example uses a selective laser melting system with a pulsed-wave laser source. However, it is intended that the methods and systems described herein can be adapted for any selective laser melting system with a continuous-wave laser source with on-off keying to provide laser pulses or for any electron beam melting systems. Also, any suitable material can be used. For instance, some example powder can be an aluminium alloy. However, it is understood that other suitable types of powder can be provided in other embodiments. For instance, the powder may include stainless steel, nickel-based alloys, titanium alloys and the like. The scope is indicated by the appended claims. As can be understood, the examples described above and illustrated are intended to be exemplary only. The scope is indicated by the appended claims.

1. A computer-implemented method of generating processing instructions for use in manufacturing a solid article in a given material from powder using a powder bed additive manufacturing system, the method comprising:
obtaining a model of the article;
receiving an indication of a first microstructure of the material for a first region of the model, the first microstructure being associated to a first cooling rate threshold based on solidification data;
determining a first sequence of energy pulses associated to the first region, wherein a parameter of each energy pulse is adapted to melt powder material and achieve a cooling rate for the material during solidification above the first cooling rate threshold, and
generating the processing instructions based on the first sequence of energy pulses.

2. The computer-implemented method of claim 1 wherein:
determining the first sequence of pulses associated to the first region comprises, for each energy pulse, taking into consideration the temperature of adjacent material to the powder material melted by the energy pulse.

3. The computer-implemented method of claim 2 comprising:
determining the first sequence of pulses associated to the first region comprises, for each energy pulse, taking into consideration the temperature of the adjacent material as affected by cooling and by heating via previous or subsequent energy pulses.

4. The computer-implemented method of claim 2 wherein:
determining the first sequence of pulses associated to the first region comprises spacing each energy pulse of the sequence in time and/or distance such that a temperature of the adjacent material at a time of the energy pulse is insignificantly influenced by previous and/or subsequent energy pulses.

5. The computer-implemented method of claim 4 wherein:
a minimum time before adjacent material is subjected to an energy pulse and/or a minimum distance for a subsequent energy pulse is determined based on a time and/or distance over which heat added through the energy pulse has an insignificant influence on local heating of the powder material.

6. The computer-implemented method of claim 5 wherein:
the first sequence of pulses associated to the first region is determined from a time-distance relationship, which defines how the minimum distance from each energy pulse changes with time.

7. The computer-implemented method of claim 2 wherein:
the cooling rate of a molten voxel subjected to the energy pulse is determined based upon the adjacent material being within a given temperature difference tolerance.

8. The computer-implemented method of claim 7 wherein:
the given temperature difference tolerance is within a predetermined tolerance of an ambient temperature of the powder material.

9. The computer-implemented method of claim 7 wherein:
a temperature of the adjacent material is 400K or below.

10. The computer-implemented method of claim 1 further comprising:
receiving an indication of a second microstructure of the material for a second region of the model, the second microstructure being associated to a second cooling rate threshold based on solidification data; and
determining a second sequence of energy pulses associated to the second region, wherein a parameter of each energy pulse is adapted to melt powder material and achieve a cooling rate for the material during solidification above the second cooling rate threshold;
wherein said generating the processing instructions is further based on the second sequence of energy pulses.

11. The computer-implemented method of claim 10 wherein:
determining the second sequence of pulses associated to the second region comprises, for each energy pulse, taking into consideration the temperature of adjacent material to the powder material melted by the energy pulse.

12. The computer-implemented method of claim 10 comprising:
determining the second sequence of pulses associated to the second region comprises, for each energy pulse, taking into consideration the temperature of the adjacent material as affected by cooling and by heating via previous or subsequent energy pulses.

13. The computer-implemented method of claim 10 wherein the parameter of each energy pulse of the first sequence is adapted to achieve a cooling rate above the first cooling rate threshold and below the second cooling rate threshold.

14.-15. (canceled)

16. The computer-implemented method of claim 1 wherein the parameter of each energy pulse of the first sequence includes a pulse shape and a pulse energy.

17. A method of manufacturing a solid article in a given material from powder using a powder bed additive manufacturing system, the method comprising:
receiving the processing instructions of claim 1; and
successively manufacturing each slice of the solid article atop one another based on the received processing instructions.

18.-22. (canceled)

23. An additive manufacturing system comprising:
one of a selective laser melting system and an electron beam melting system;
a computer coupled to the one of the selective laser melting system and the electron beam melting system and configured for
obtaining a model of the article;
receiving an indication of a first microstructure of the material for a first region of the model, the first microstructure being associated to a first cooling rate threshold based on solidification data;
determining a first sequence of energy pulses associated to the first region, wherein a parameter of each energy pulse is adapted to melt powder material and achieve a cooling rate for the material during solidification above the first cooling rate threshold; and
generating the processing instructions based on the first sequence of energy pulses.

24. An additive manufacturing system of claim 23 wherein:
the computer is configured for determining the first sequence of pulses associated to the first region by, for each energy pulse, taking into consideration the temperature of adjacent material to the powder material melted by the energy pulse.

25. An additive manufacturing system of claim 24 wherein:
the computer is configured for determining the first sequence of pulses associated to the first region by taking into consideration the temperature of the adjacent material as affected by cooling and by heating via previous or subsequent energy pulses.

26. The additive manufacturing system of claim 23 wherein the computer is configured for:
receiving an indication of a second microstructure of the material for a second region of the model, the second microstructure being associated to a second cooling rate threshold based on solidification data; and
determining a second sequence of energy pulses associated to the second region, wherein a parameter of each energy pulse is adapted to melt powder material and achieve a cooling rate for the material during solidification above the second cooling rate threshold;
wherein said generating the processing instructions is further based on the sequence of laser energy.

27. An additive manufacturing system of claim 26 wherein:
the computer is configured for determining the second sequence of pulses associated to the second region by, for each energy pulse, taking into consideration the temperature of adjacent material to the powder material melted by the energy pulse.

28. An additive manufacturing system of claim 27 wherein:
the computer is configured for determining the second sequence of pulses associated to the first region by taking into consideration the temperature of the adjacent material as affected by cooling and by heating via previous or subsequent energy pulses.

29. The additive manufacturing system of claim 26 wherein the parameter of each energy pulse of the first sequence is adapted to achieve a cooling rate above the first cooling rate threshold and below the second cooling rate threshold.

30.-32. (canceled)
